(19) United States
(12) Patent Application Publication
(10) Pub. No.: US 2009/0004475 A1
(43) Pub. Date: Jan. 1, 2009

(54) MAGNETIC MATERIALS MADE FROM MAGNETIC NANOPARTICLES AND ASSOCIATED METHODS

(76) Inventors: Mariam Sadaka, Austin, TX (US); Chris Young, Austin, TX (US); Rahul Ganguli, Agoura Hills, CA (US); Vivek Mehrotra, Simi Valley, CA (US)

Correspondence Address: JOHNSON & ASSOCIATES, PO BOX 90698, AUSTIN, TX, 78709-0698, US

(21) Appl. No.: 11/769,437

(22) Filed: Jun. 27, 2007

(51) Int. Cl. B32B 5/16; B05D 5/12

(52) U.S. Cl. 428/403; 427/130; 428/402

(57) ABSTRACT

A method and apparatus is provided for creating soft magnetic materials for low-loss inductive devices that achieves low eddy currents, low coercivity, and high permeability at high frequency. The soft magnetic material utilizes magnetic nanoparticles that take advantage of desired properties of two or more particle types. The magnetic nanoparticles are single domain particles that are optimized to enhance exchange coupling.

### FIELD OF THE INVENTION

This invention relates to the field of magnetic materials. In particular, this invention is drawn to soft magnetic materials made from magnetic nanoparticles.

### BACKGROUND OF THE INVENTION

Magnetic materials are commonly used in inductive components (e.g., inductors, transformers, etc.) in electronic devices. Magnetic materials are used to form inductive cores, having various shapes and configurations. Ideal magnetic materials for inductors or transformer cores have high saturation magnetization (M_{S}), high permeability (μ), and low energy losses. In some electronic devices, such as high frequency switched mode power supplies, inductors that can handle the required frequencies are very large, and have other limitations. For example, typical prior art inductors have low permeability and experience an increase in eddy current losses at high frequencies. Also, typical prior art inductors may experience high anisotropy and demagnetization effects at high frequencies.

Typical prior art soft magnetic materials used in inductive cores include ferrites, silicon steel, cobalt alloys, nickel iron, and others. All of these magnetic materials suffer from the problems mentioned above, when used at high frequencies. Other materials, such as nanocrystalline soft magnetic materials (e.g., Finemet®) have similar problems. For example, Finemet® suffers from a drop in permeability at high frequencies. Also, core losses increase at high frequencies.

It is evident that there is a need for soft magnetic materials that can be used to make low-loss inductive devices for high frequency applications (e.g., switched mode power supplies, etc.) that can maintain adequate magnetic properties (e.g., high permeability, high saturation magnetization, etc.) at high frequencies. Such superior magnetic material enables an increase in the system operating frequency (f), which contributes to smaller inductive devices by a factor of 1/f. This satisfies a need for inductive devices that are smaller in size to reduce costs and save valuable board space and improve overall system efficiency. FIG. 1B shows a signal diagram and equations illustrating the relationship between the inductance and frequency. As illustrated, the inductance (L) is inversely proportional to the frequency (f_{S}), and thus the benefit of shrinking the inductor size when operating at higher frequencies.

### SUMMARY OF THE INVENTION

A soft magnetic material of the invention includes magnetic nanoparticles, wherein the magnetic nanoparticles are comprised of particles containing three or more elements, and wherein each of the three or more elements has properties that contribute to desired magnetic characteristics.

Another embodiment of the invention provides a soft magnetic material including a plurality of magnetic nanoparticles, wherein the magnetic nanoparticles are comprised of a first material forming a core, a second material forming a shell around the core, and a third material forming a coating around the shell.

Another embodiment of the invention provides a soft magnetic material including magnetic nanoparticles, wherein the magnetic nanoparticles are include a mixture of two different types of magnetic nanoparticles, wherein each type of magnetic nanoparticles has characteristics that contribute to desired magnetic properties.

Another embodiment of the invention provides a method of making soft magnetic material using magnetic nanoparticles including forming a plurality of magnetic nanoparticles using two or more different compounds that provide different desired magnetic properties, configuring the magnetic nanoparticles to be single domain particles, configuring the magnetic nanoparticles to enhance exchange coupling, coating the magnetic nanoparticles using a magnetic material, and compacting the magnetic nanoparticles.

Other features and advantages of the present invention will be apparent from the accompanying drawings and from the detailed description that follows below.

### BRIEF DESCRIPTION OF THE DRAWINGS

The present invention is illustrated by way of example and not limitation in the figures of the accompanying drawings, in which like references indicate similar elements and in which:

FIG. 1A illustrates a block diagram of a switched mode power supply with an inductor utilizing the present invention.

FIG. 1B shows a signal diagram and equations illustrating the relationship between the inductance and frequency.

FIG. 2 is a diagram illustrating adjacent magnetic nanoparticles.

FIG. 3 is a diagram illustrating adjacent magnetic nanoparticles coated with a coating material.

FIG. 4 shows a hysteresis loop illustrating the relationship between the induced magnetic flux density and the magnetizing force.

FIG. 5 is a sectional diagram of a multi-layer magnetic nanoparticle of the present invention.

FIG. 6 is a sectional diagram of two adjacent multi-layer magnetic nanoparticles of the present invention.

FIG. 7 is a diagram showing a mixture of two types of soft magnetic nanoparticles.

FIG. 8 is a diagram showing a mixture of two types of soft magnetic nanoparticles, with one of the types of nanoparticles coated.

FIG. 9 is a sectional diagram of a explosion compaction device.

FIGS. 10-12 are sectional diagrams illustrating grain growth in compacted nanoparticles.

FIG. 13 is a diagram illustrating particles with two size distributions.

FIG. 14 is a flowchart illustrating one example of a process for creating a magnetic device using magnetic nanoparticles.

### DETAILED DESCRIPTION

In order to provide a context for understanding this description, the following description illustrates one example of an environment in which the present invention may be used. Of course, the invention may also be used in many other types of environments where magnetic materials are needed. As mentioned above, electronic devices such as high-frequency switched mode power supplies use large inductors, which must be able to handle high frequencies, while maintaining various magnetic properties. A typical high-frequency switched mode power supply is a power supply that incorporates a switching regulator that switches one or more power transistors rapidly on and off in order to generate a desired output voltage.

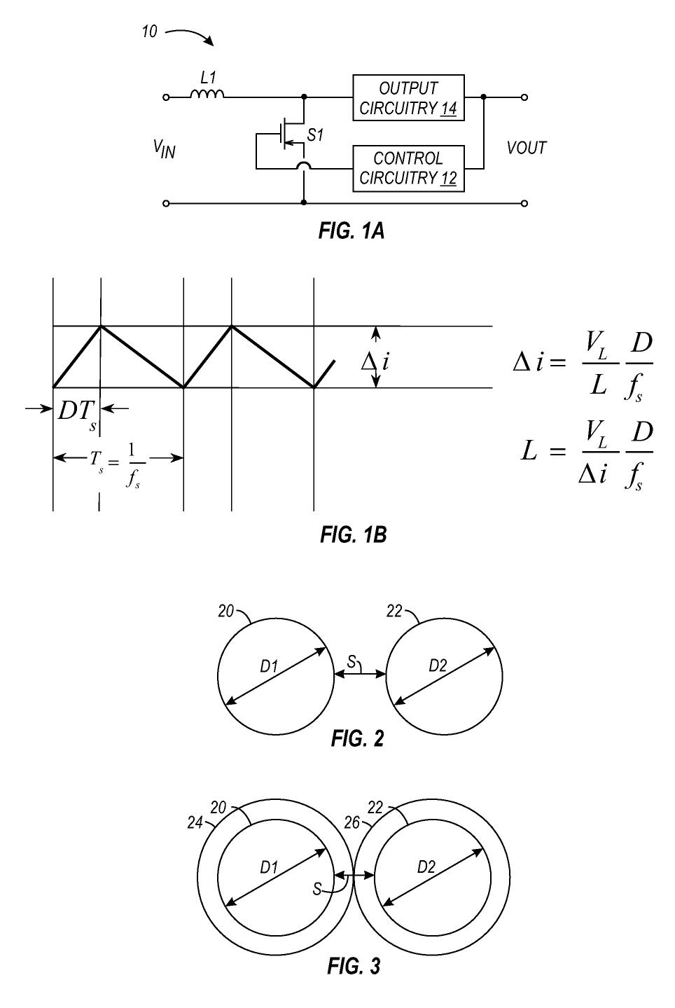

As an example, FIG. 1A illustrates a block diagram of a switched mode power supply 10. The switched mode power supply 10 receives an input voltage V_{IN} and generates an output voltage V_{OUT}. Control circuitry 12 turns switch SI (e.g., a MOSFET) on and off repeatedly, to generate a desired output voltage V_{OUT}. When the switch S1 is closed, current flows through the inductor L1 to ground. When the switch S1 is open, energy stored in the inductor flows through the output circuitry 14 to the output V_{OUT}. The output circuitry 14 may contain any desired circuitry, such as transformers, filters, etc. Note that FIG. 1A is merely one example of circuitry that uses an inductor that may benefit from magnetic material of the present invention.

The present invention provides techniques for making magnetic materials that can be used to create low loss inductive devices for applications such as switched mode power supplies. Inductive devices created using the present invention are capable of maintaining adequate magnetic properties (high saturation magnetization, high permeability, low energy losses, etc.) at high frequencies (e.g., 10 MHz and higher). When inductive devices utilizing the present invention are used in high frequency circuits, not only will the inductive devices realize an improved performance, but other portions of the circuit may be able to be simplified. For example, in the example of a power supply, a more efficient inductor may enable the use of cheaper FET's and the use of silicon devices in place of more expensive silicon carbide (SiC) devices. In addition, by operating at a high frequency, an electronic device can have an increased power density. An electronic device utilizing the present invention can be made smaller than similar prior art devices.

Generally, the present invention relates to the fabrication of coated and compacted soft magnetic material to achieve high permeability, low coercivity, low eddy currents, etc. The invention uses nanocomposite materials, comprised of magnetic nanoparticles embedded in a dielectric matrix. The nanocomposite materials are desirable for electromagnetic device applications at high frequencies (e.g., inductors, DC-DC converters, etc.). Briefly, the present invention achieves its objectives using the following guidelines, each of which is described in detail below. First, single domain magnetic nanoparticles are used to realize low coercivity and high permeability. The magnetic material selection is optimized based on the exchange length of the particles to ensure that particles are exchange coupled. Two or more types of soft magnetic material are used, realizing the benefits of each type of material. For example, high magnetization material can be used to achieve desired magnetic properties, while high exchange length material can be used to maximize exchange coupling between particles. Rather than using an insulator, the magnetic particles are coated using ferro or ferrimagnetic ferrite to enhance exchange coupling. The types of coatings used in typical prior art applications can shield the exchange process and degrade performance. Also, the thickness of the particle coatings is kept low, relative to the core diameter, to maximize the percentage of core material in the matrix. The soft magnetic material is compacted using a rapid, low temperature compaction technique to help prevent grain growth. Finally, the compacted magnetic material is annealed to relieve mechanical stresses in the material. This further reduces losses.

A magnetic domain is a region in which the magnetic fields of atoms are grouped together and aligned. When a material becomes magnetized, all like magnetic poles are lined up and point in the same direction. If a particle is small enough, the particle can have only one domain, and is referred to as a single domain particle. Single domain particles are desired to maximize permeability and to minimize coercivity. Permeability can be represented using the following equation:

$$μ α \frac{{J}_{s}^{2} {A}^{3}}{{μ}_{0} {D}^{6} {K}_{1}^{4}} α {D}^{- 6} , \qquad ( 1 )$$

where μ is permeability, J is Saturation magnetization, A is Exchange Stiffness, μ₀ is the permeability of free space, D is the grain size, and K is the anisotropy constant. As shown, permeability is inversely proportional to the grain size D. Coercivity can be represented using the following equation:

$$H α \frac{{K}_{1}^{4} {D}^{6}}{{J}_{s} {A}^{3}} α {D}^{6} , \qquad ( 2 )$$

where H is coercivity, K is anisotropy constant, D is the grain size, J is Saturation magnetization, and A is Exchange Stiffness. As shown, coercivity is proportional to the grain size D. Therefore, generally, it is desirable to have a small grain size to maximize permeability and to minimize coercivity. Single domain grain is uniformly magnetized to its saturation magnetization. Generally, if the metal particle size distribution is less than the domain wall thickness of the material, then the magnetic material will be single domain, resulting in high permeability and low coercivity. Therefore, the careful selection of alloys with large domain walls helps to ensure magnetic material with single domain nanoparticles.

As mentioned above, the selection of magnetic material is important. One consideration when selecting magnetic material relates to exchange coupling. Exchange coupling can be ensured by selecting an alloy that has a relatively long exchange length (Lex). Exchange coupling between adjacent magnetic nanoparticles can overcome the anisotropy and the demagnetizing effect (the cancellation of magnetic and anisotropy of individual magnetic nanoparticles). If magnetic materials having relatively long exchange lengths are used, adjacent magnetic nanoparticles separated by distances shorter than the exchange length can be magnetically coupled by exchange interaction. Ferromagnetic exchange coupling dramatically reduces anisotropy, and significantly enhances permeability.

FIG. 2 is a diagram illustrating adjacent magnetic nanoparticles. A first magnetic nanoparticles 20 is separated by distance S from a second magnetic nanoparticle 22. The first nanoparticle 20 has a particle size, or diameter of D1. The second nanoparticle 22 has a particle size, or diameter of D2. As described above, preferably, the particle sizes D1 and D2 are less than the domain wall of the selected magnetic material, resulting in single domain particles. With respect to exchange coupling, the magnetic nanoparticles 20 and 22 will be exchange coupled if the separation S is less than the exchange length (Lex) of the magnetic material selected.

Typically, the particles 20 and 22 will include a coating material. FIG. 3 is a diagram illustrating adjacent coated magnetic nanoparticles. The first magnetic nanoparticle 20 is coated by coating 24, while the second magnetic nanoparticle 22 is coated by coating 26. The coatings 24 and 26 are comprised of magnetic materials such as ferro or ferrimagnetic ferrites to enhance exchange coupling. Specific examples of coating materials are described in detail below. In this example, the coatings of particles 20 and 22 are touching, which will happen after the particles are compacted. In this example, the particles 20 and 22 are separated by distance S, which corresponds approximately to the total thickness of the coatings 24 and 26. If the separation S is less than the exchange lengths of the magnetic nanoparticles, the magnetic nanoparticles 20 and 22 will be exchange coupled. It is therefore evident that exchange coupling can be controlled based on various design parameters such as particle size, the magnetic material used, and the thickness and material properties of the coatings.

One important aspect of the present invention involves selecting the type of magnetic material used to make the magnetic nanoparticles. Ideally, a selected material will have a high permeability (e.g., nanocrystalline alloys), a long exchange length, and a large domain wall. However, different types of magnetic materials will have different advantages and disadvantages. So, by selecting a particular material, trade-offs are involved. For example, two types of available magnetic nanoparticles include FeCo (at a 50:50 ratio) (i.e., Iron Cobalt) and FeNi (at a 25:75 ratio) (i.e., Iron Nickel). Iron cobalt has a high saturation magnetization, but a relatively small domain wall (˜45 nm), and a relatively short exchange length (1.9 nm). On the other hand, Iron Nickel has a relatively large domain wall (˜150 nm) and a relatively large exchange length (10.5 nm). As a result, a typical designer may choose iron cobalt where a high saturation magnetization is desired, or Iron Nickel where exchange coupling is more important.

One aspect of the present invention involves using two or more types of soft magnetic material to realize benefits of each type of material. In one embodiment, each magnetic nanoparticle is made of a compound comprised of three or more elements. In one example, each magnetic nanoparticle includes iron, cobalt, and nickel. If desired, an element, such as copper, can be added to help with the structure of the magnetic material. Only a small amount of copper may be required (for example, 1%) to enhance the structural integrity of the magnetic material. Magnetic material comprised of an FeCoNi—Cu alloy will have low coercivity and high permeability. The FeCoNi—Cu composition is optimized to take full advantage of the benefits of each included element. The iron (Fe) provides high saturation induction. The cobalt (Co) provides high permeability. The nickel (Ni) provides a low magnetic moment. The copper (Cu) controls the grain growth and reduces stress in the magnetic matrix. In one example, the FeCoNi—Cu magnetic nanoparticles are provided in sizes of approximately 20 nm, which enables the benefits described above (e.g., single domain magnetic particles and exchange coupling). In addition, a magnetic coating (described in detail below) may be used to reduce eddy currents and enhance exchange coupling.

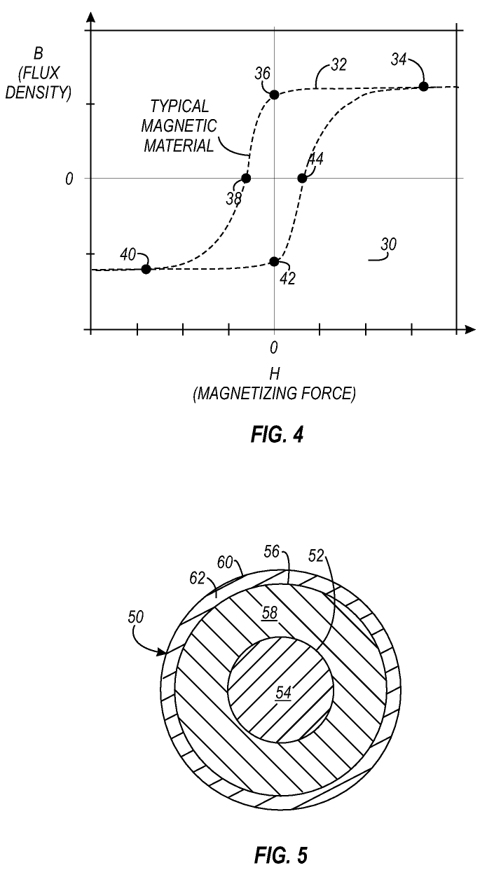

FIG. 4 shows a hysteresis loop illustrating the relationship between the induced magnetic flux density (B) and the magnetizing force (H). This is commonly referred to as a B-H loop. A B-H loop is generated by measuring the magnetic flux of a magnetic material while an applied magnetic force is changed. FIG. 4 illustrates the B-H loop of a typical magnetic material (the dashed lines). FIG. 4 shows a B-H loop 32, corresponds to a typical magnetic material. As shown, the greater the amount of magnetizing force (H+) applied, the stronger the magnetic field in the magnetic material (B+). Referring to B-H loop 32, node 34 corresponds to a point when almost all of the magnetic domains are aligned and any additional increase in the magnetizing force will produce very little increase in magnetic flux. This point is known as magnetic saturation. When the magnetizing force is reduced to zero, the curve will move from node 34 to node 36. At this point, there is some magnetic flux left in the magnetic material even though the magnetizing force is zero. This point is referred to as the point of retentivity and indicates a residual magnetism in the magnetic material. As the magnetizing force is reversed, the B-H curve moves to node 38, where the flux density has been reduced to zero. This is referred to as the point of coercivity, where the reversed magnetizing force has flipped enough of the domains such that the net flux within the magnetic material is zero. As the negative magnetizing force is increased, the magnetic material will saturate again at node 40. Reducing the magnetizing force to zero brings the B-H curve to node 42, where the magnetic material has some level of residual magnetism equal to that at node 36. As the magnetizing force increases in the positive direction, the B-H curve will return to zero at node 44.

Various properties of a magnetic material can be learned from its B-H loop. As mentioned above, the value at node 36 indicates the retentivity of the magnetic material, which is the ability of the magnetic material to retain a certain amount of magnetic field when the magnetizing force is removed right before achieving saturation. The amount of reverse magnetic field which must be applied to the magnetic material to return the magnetic flux to zero is known as the coercive force (node 38).

In another example, the selection of magnetic material for magnetic nanoparticles involves the use of multi-layered nanoparticles. As described above, different magnetic materials provide different advantages over other materials, and trade-offs are involved when trying to select a preferred magnetic material. The present invention provides another technique for combining the beneficial magnetic properties of two or more different materials, resulting in a single magnetic device possessing the beneficial properties of each material. In this example, a magnetic nanoparticle is comprised of two or more types of material configured in a multi-layer arrangement. For example, a first magnetic material may form the core of a particle, while a second magnetic material forms the shell of the particle. The resulting dual particle mixture results in a magnetic device possessing the beneficial magnetic properties of both the core material and the shell material.

FIG. 5 is a sectional diagram of a multi-layer magnetic nanoparticle of the present invention. FIG. 5 shows a cross sectional diagram of a magnetic nanoparticle 50, that combines two or more different magnetic materials to form a dual particle mixture. In other examples, three or more different magnetic materials may be combined. The magnetic nanoparticle 50 has a core 52, which is comprised of a core material 54. A shell 56 is formed around the core 52, which is comprised of a shell material 58. The core material 54 and shell material 58 are different magnetic materials, having different magnetic properties. In one example, the core material 54 is a material with a high saturation magnetization, a relatively small domain wall, and a relatively short exchange length. In this example, the shell material 58 has a relatively large exchange a length and a relatively large domain wall.

One example of a magnetic material that matches the description of the core material in the example given above is iron cobalt (FeCo), at a 50:50 ratio. Iron cobalt has high saturation magnetization and therefore provides a high magnetization core, which is a desirable magnetic property. Iron cobalt has a relatively short exchange length (1.9 nm) and a relatively small domain wall (˜45 nm). However, these limitations do not case a problem in the multi-layer nanoparticle of FIG. 5. In this example, the core 52 is small enough that the core 52 is a single domain particle. Also, since the distance between the core material 54 and the adjacent shell material 58 is virtually zero, the core material 54 and shell material 58 will be exchange coupled, despite the short exchange length.

One example of a magnetic material that matches the description of the shell material given above is iron nickel (NiFe), at a 75:25 ratio. Iron nickel has a relatively large domain wall (˜150 nm), which allows the shell 56 to be larger than materials with smaller domain walls, while still being a single domain particle. Also, iron nickel has a relatively long exchange length, which helps to ensure that adjacent multi-layer nanoparticles are exchange coupled with each other.

The multi-layer magnetic nanoparticle 50 has a coating 60 that coats the shell 56. The coating 60 is comprised of a coating material 62, which may comprise magnetic materials such as ferro or ferrimagnetic ferrites to enhance exchange coupling. Specific examples of coating materials are described in detail below.

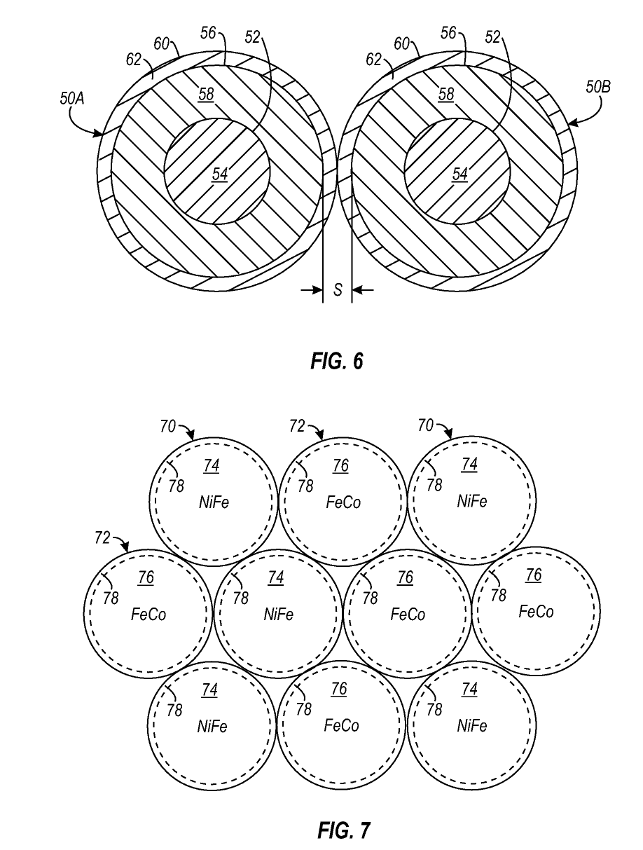

FIG. 6 is a sectional diagram of two to adjacent multi-layer magnetic nanoparticles 50A and 50B. Nanoparticles 50A and 50B in this example are the same as magnetic nanoparticle 50 shown in FIG. 5. As illustrated in FIG. 6, the magnetic nanoparticles 50A and 50B are touching, which would commonly occur after the particles have been compacted (as described in detail below). The shell material 58 of the magnetic nanoparticle 50A is separated from the shell material 58 of the magnetic nanoparticle 50B by a distance shown as S. As long as the exchange length of the shell material 58 is greater than the distance S, then the shell material 58 of adjacent magnetic nanoparticles 50A and 50B will be exchange coupled. Therefore, exchange coupling between adjacent shell materials can be controlled by selecting a proper shell material and a proper coating thickness. In the example of a shell material comprising iron nickel, having an exchange length of 10.5 nm, adjacent magnetic nanoparticles will be exchange coupled with each other as long as the total coating thickness of the two adjacent nanoparticles is less than 10.5 nm. For example, if the thickness of the coatings 60 of the magnetic nanoparticles were 5 nm, then the shell material 58 of the adjacent nanoparticles would be only 10 nm apart, and would be exchange coupled.

FIG. 6 also helps to illustrate how the core material 54 and shell material 58 may be selected to enhance exchange coupling. In this example, the shell material 58 should be the material system with the longer exchange length, as compared to the exchange length of the core material 54. If the shell material 58 had a relatively short exchange length, adjacent nanoparticles may not be exchange coupled. Also, since the core material 54 touches the shell material 58, a relatively short exchange length in the core material is tolerable.

In other examples, a multi-layer nanoparticle may include three or more layers of soft magnetic material. Also, in other examples it may be possible to provide magnetic nanoparticles without a coating, or to provide some nanoparticles with a coating and others without. In another example, a coating layer could be disposed between the nanoparticle core and shell. Also note that after the soft magnetic material is compacted (described below) the shapes of the nanoparticles may be deformed, as compared to the sectional diagrams shown in FIGS. 5 and 6.

In another example, the selection of magnetic material for magnetic nanoparticles involves the use of a mixture of different types of nanoparticles. Like the examples described above, different magnetic materials provide different advantages and disadvantages. The present invention provides another technique for combining the beneficial magnetic properties of two or more different magnetic materials, resulting in a magnetic device that possesses some of the beneficial properties of each material. In this example, a soft magnetic material is comprised of a mixture of two or more types of magnetic nanoparticles, each having different characteristics that contribute to various desired magnetic properties.

In one example, the mixture includes nanoparticles that have a high magnetization to provide desired magnetic properties. In this example, the mixture also includes nanoparticles that have a high exchange length to enable and enhance exchange coupling between particles. Finally, in this example, both types of nanoparticles are configured to be single domain particles. Based on the desired magnetic properties outlined in this example, two suitable materials for magnetic nanoparticles include iron cobalt (FeCo), at a 50:50 ratio and iron nickel (NiFe), at a 75:25 ratio. Iron cobalt has a high saturation magnetization and therefore provides a high magnetization core for desirable magnetic properties. Iron cobalt has a relatively short exchange length (1.9 nm) and a relatively small domain wall (˜45 nm). Iron nickel has a relatively large domain wall (˜150 nm), which makes it easier to configure the particles to be single domain particles. Iron nickel also has a relatively long exchange length, which helps to ensure that adjacent nanoparticles are exchange coupled. In this example, the mixture of iron cobalt and iron nickel will result in a magnetic device having superior magnetic properties over typical prior art magnetic devices.

FIG. 7 is a diagram showing a mixture of two types of soft magnetic nanoparticles. The two types of nanoparticles shown are taken from the example described above. A first type of magnetic nanoparticle 70 is comprised of a first magnetic material 74, in this example, iron nickel. A second type of magnetic nanoparticle 72 is comprised of a second magnetic material 76, in this example, iron cobalt. Each of the nanoparticles shown in FIG. 7 includes an optional coating 78 to reduce eddy current losses. The coating 78 of each nanoparticle is preferably made from a magnetic material, as described below. Typically, a mixture of different types of magnetic nanoparticles will result in a random distribution of the nanoparticles throughout the magnetic material.

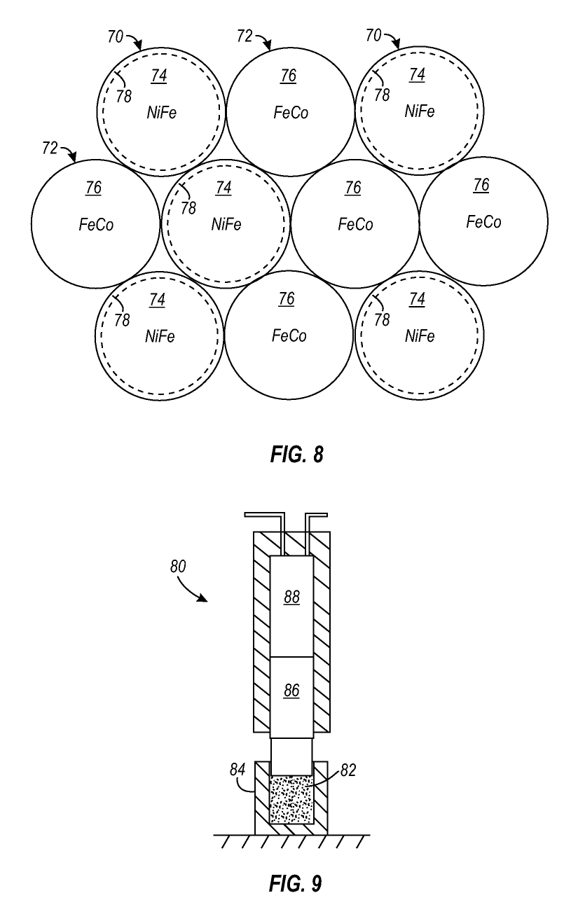

There are numerous variations of nanoparticle mixtures that fall within the spirit and scope of the present invention. In one example, the iron cobalt nanoparticles 72 do not have a coating to improve the exchange coupling of particles. Since iron cobalt has a relatively short exchange length, the iron cobalt material will be disposed closer to adjacent particles, which results in a better chance of exchange coupling. FIG. 8 is a diagram showing a mixture of two types of soft magnetic nanoparticles, where one type of nanoparticle is not coated. As shown in FIG. 8, the nanoparticles 72, comprised of iron cobalt, do not have coating. As mentioned above, this improves the exchange coupling between the iron cobalt particles and adjacent particles, since the separation between particles is shortened. One potential drawback to this arrangement is that adjacent iron cobalt particles may not be insulated from one another, creating weak spots in the magnetic material. Solutions to this drawback may include ensuring that the iron cobalt particles are uniformly disbursed, and/or increasing the concentration of the iron nickel particles to reduce the occurrence of weak spots in the magnetic material.

In the examples described above, most of the nanoparticles mentioned include a coating, which coat the entire nanoparticle. A primary purpose of the coating is to reduce eddy currents, and therefore reduce losses in the magnetic material. To select desirable coatings for nanoparticles, it is helpful to understand the purpose of the coating, and why coatings can be beneficial to the magnetic properties of the magnetic material. As mentioned, one purpose of a nanoparticle coating is to reduce eddy current losses. Eddy current losses are proportional to frequency, and inversely proportional to resistivity, as the following equation illustrates:

$$Eddy current losses ∝ \frac{{Af}^{2}}{ρ} , \qquad ( 3 )$$

where A is a constant, f is frequency, and ρ is resistivity. Since one goal is to reduce eddy current losses, it is desirable that a coating be resistive. In addition, a resistive coating would also increase the skin depth (δ), as illustrated in the following equation:

$$δ = \sqrt{\frac{ρ}{π f μ}} , \qquad ( 4 )$$

where ρ is resistivity, f is frequency, and μ is permeability. When magnetic particles are close enough together, there may be conduction between the particles. The nanoparticle coating interrupts this conduction by putting the highly resistive coating around the particles to increase the skin depth. Another consideration when selecting a material for the coating, is that it is desirable that the coating be inert, in other words, it is desirable that the coating not react with the nanoparticles after the compaction process. Also, it is desirable that the coating remains stable during and after the compaction process.

As mentioned above, in some examples, coating materials of the present invention can be ferro or ferrimagnetic. By using a magnetic material such as a ferrite, instead of an insulator like prior art coatings (e.g. SiO₂), exchange coupling is enhanced. If nonmagnetic insulators are used as coatings, the coatings can actually shield the exchange coupling process, which is undesirable. Similarly, an anti-ferromagnetic coating (e.g., alpha Fe₂O₃) can degrade performance of the magnetic device.

There are numerous coatings that are suitable for use with the present invention. Examples of suitable coatings include, but are not limited to, gamma Fe₂O₃, a NiFe ferrite, a FeCo ferrite, and other ferrites.

Nanoparticles can be coated using any desired manufacturing process. For example, coatings can be applied in-situ as the process used to form the particles to reduce the handling of the nanoparticles. In addition, by coating the nanoparticles in-situ, the possibility of exposing the nanoparticles to the atmosphere (which would result in undesirable oxidation of the nanoparticles) is reduced.

Another consideration when coating nanoparticles relates to the coating thickness. As mentioned above, it is desirable to keep the coating thickness to less than one half the exchange length of the nanoparticles to maintain exchange coupling. In addition, it is desirable to keep the coating thickness low enough that the total volume of the coating is as small as possible, relative to the volume of the nanoparticle core, to maximize the core material in the magnetic matrix. As the nanoparticle coating thickness increases, the coating volume can dominate the total volume, reducing the magnetic properties of the magnetic material. Therefore, when designing magnetic materials from magnetic nanoparticles, it is important to attempt to minimize the coating thickness, while maximizing the core diameter.

Magnetic nanoparticles of the present invention may be manufactured in any desired manner. Following are examples of suitable techniques for manufacturing magnetic nanoparticles of the present invention. Of course, numerous other manufacturing techniques may also be used within the spirit and scope of the invention. The magnetic nanoparticles described above can be manufactured using any desired technique such as a gas phase plasma process. One goal during the manufacturing of magnetic nanoparticles is to prevent the particles from being exposed to air, since the air may oxidize the particles. If the nanoparticles are coated in-situ, then the nanoparticles will be protected from the atmosphere before they leave the reactor.

Once the magnetic nanoparticles are manufactured, they must be formed into the desired magnetic device. For example, for an inductor, the nanoparticles may be formed into a toroid (or other) shape. For a transformer, the nanoparticles may be formed into any desired shape, as desired. One way of forming magnetic devices from nanoparticles is by compaction. In a compaction process, the magnetic particles are compressed and compacted to form the desired magnetic device. In one example, rapid, low-temperature compaction is used to achieve a high packing density and to help prevent grain growth. FIG. 9 is a simplified cross-sectional diagram of an explosion driven compaction device 80. One suitable compaction device is manufactured by Utron Inc. of Manassas, Va. The Utron compaction device is described in detail in U.S. Pat. No. 6,767,505, which is incorporated by reference herein. The compaction device 80 shown in FIG. 9 compacts magnetic nanoparticles 82 within a die 84. A high-pressure piston 86 compacts the nanoparticles 82 when gas within a gas chamber 88 is ignited. The nanoparticles 82 are compacted and compressed into a densely formed part. This process is very fast, and happens at room temperature, which reduces the strain normally induced by compaction processes.

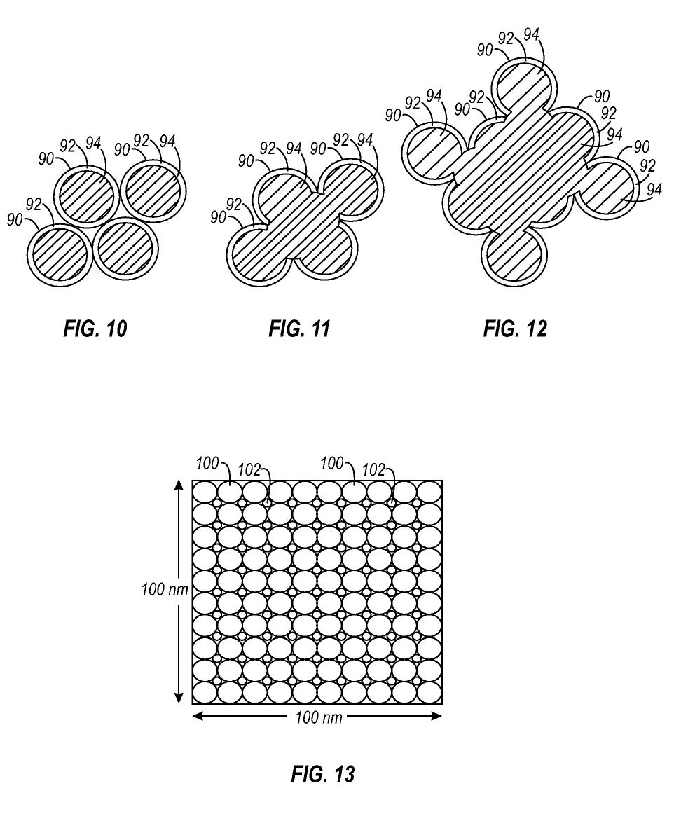

As mentioned above, one goal when manufacturing magnetic devices is to optimize the compaction of the nanoparticles. On one hand, if the compaction is incomplete, a small amount of porosity from the incomplete compaction can lead to significant demagnetization. On the other hand, grain growth can take place and thus reduce the magnetic induction and severely increase losses. FIGS. 10-12 are sectional diagrams illustrating grain growth in compacted nanoparticles. FIG. 10 shows a plurality of nanoparticles 90, each having a magnetic core 94 and a coating 92, as described above. In FIG. 10, the nanoparticles are compacted, and no grain growth is present. As shown in FIG. 10, the coatings 92 of the nanoparticles 90 are intact. Grain growth is caused when the coating around nanoparticles breaks during compaction. In FIG. 11, some of the coatings 92 of the nanoparticles 90 have broken, resulting in a small amount of grain growth. As shown, when grain growth occurs, the core magnetic material from adjacent particles is compacted together. FIG. 12 illustrates an example of severe grain growth. As shown, a lot of the coatings 92 of the nanoparticles 90 are broken. Also, a large amount of the core magnetic material is compacted together. Severe grain growth results in electrical percolation, which may result in magnetic material thicknesses that are larger than the skin depth. At high frequencies, this reduces the magnetic induction, severely increasing loss. Therefore, it is important to properly compact the nanoparticles by using the appropriate amount of pressure at the appropriate temperature to minimize grain growth.

If desired, the compacted magnetic nanoparticles can be annealed to relieve mechanical stress in the compacted particles. Typically, annealing involves applying heat or ultrasonic energy to the compacted particles in an inert gas, such as hydrogen, nitrogen, argon, etc. In addition to relieving mechanical stress, annealing also helps to reduce losses in the magnetic material.

As described above, creating magnetic material using a mixture of different types of magnetic particles has advantages. In another example, a higher green density (the weight per unit volume of an unsintered compaction) can be achieved when contacting particles having a different size distribution. The mixture of two different soft magnetic nanoparticles will typically have two different domain lengths, and therefore should result in at least two particle size distributions. This results in a higher green density. FIG. 13 is a diagram illustrating how particles with two size distributions can result in a higher green density. A first type of magnetic nanoparticle 100 is shown distributed within an area. In this example, the area shown is 100 nm by 100 nm. The nanoparticles 100 are single domain particles having a domain length of approximately 10 nm. A second type of magnetic nanoparticle 102 is shown distributed between the nanoparticles 100. As shown, the nanoparticles 102 are smaller than the nanoparticles 100. The resulting magnetic material has a higher green density than it would with the nanoparticles 100 alone. Even when using a single magnetic particle alloy, nanoparticles will have a size distribution due to inherent properties of the manufacturing processes used to form the nanoparticles. In this example, techniques such as sieving can be used to truncate the distribution by removing particles larger than the domain wall thickness. This ensures single domain particles, while also allowing a higher green density due to the varying size of the particles.

The techniques described above can also be applied to other applications. For example, in any application where magnetic materials are required. Also the nanoparticle techniques may also be applied to the fabrication of other types of devices, such as capacitors, etc.

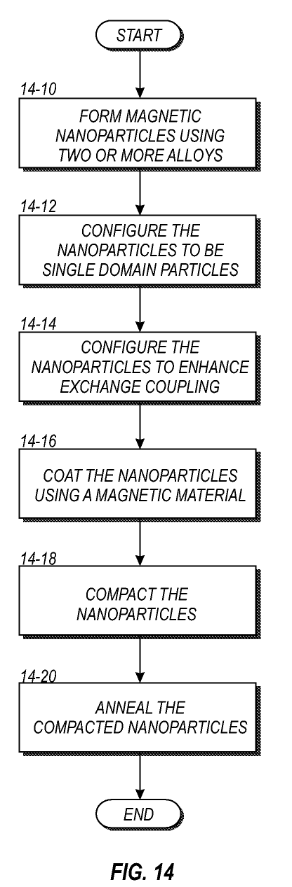

FIG. 14 is a flowchart illustrating one example of a process for creating a magnetic device using magnetic nanoparticles. Note that FIG. 14 is merely one example, and that the present invention can be practiced in numerous ways, and used in other applications. The process illustrated in FIG. 14 begins at step of 14-10, were magnetic nanoparticles are formed using two or more alloys. Using one or more of the techniques described above, magnetic devices can be made that take advantage of different desired magnetic properties of different magnetic alloys. For example, a tertiary alloy may be used that takes advantage of desired magnetic properties of three different elements (FIG. 4). In another example, multi-layer magnetic nanoparticles can be used that take advantage of desired magnetic properties of the material in each layer (FIGS. 5-6). In another example, a mixture of different magnetic nanoparticles can be used (FIGS. 7-8). Other examples may also be used.

At step 14-12, the nanoparticles are configured to be single domain particles. As described above, single domain magnetic particles will result in low coercivity and high permeability, which is desired. The nanoparticles can be configured to be single domain particles by ensuring that the size of the particles is less than the domain wall of the material making up the particles. Next, at step 14-14, the nanoparticles are configured to enhance exchange coupling. Particles that are exchange coupled will realize low anisotropy and have better magnetic properties than particles that are not exchange coupled. The nanoparticles can be configured to enhance exchange coupling by controlling the type of material, controlling the thickness of particle coatings, and controlling the distances between materials, etc.

Next, at step 14-16, the nanoparticles are coated using a magnetic insulator material. As described above, if the coating material is a ferro or ferrimagnetic ferrite, exchange coupling is enhanced. At step 14-18, the nanoparticles are compacted using a compaction technique. In one example, a rapid, low-temperature high-pressure compaction technique is used, such as explosion driven compaction. Finally, if desired, the compacted nanoparticles can be annealed to relieve mechanical stress and reduce losses.

In the preceding detailed description, the invention is described with reference to specific exemplary embodiments thereof. Various modifications and changes may be made thereto without departing from the broader spirit and scope of the invention as set forth in the claims. The specification and drawings are, accordingly, to be regarded in an illustrative rather than a restrictive sense.

1. A soft magnetic material comprising magnetic nanoparticles, wherein the magnetic nanoparticles are comprised of particles containing three or more metallic elements, and wherein each of the three or more metallic elements has properties that contribute to desired magnetic characteristics.

2. The soft magnetic material of claim 1, wherein the magnetic nanoparticles comprise a first element that contributes to a high saturation, a second element that contributes to a high permeability, and a third element that contributes to a low magnetic moment.

3. The soft magnetic material of claim 1, wherein the magnetic nanoparticles comprise the elements Fe, Co, and Ni.

4. The soft magnetic material of claim 3, wherein the magnetic nanoparticles further comprise the element Cu.

5. The soft magnetic material of claim 1, wherein the magnetic nanoparticles are single domain particles.

6. The soft magnetic material of claim 1, wherein the magnetic nanoparticles each include a magnetic coating material.

7. The soft magnetic material of claim 6, wherein the thickness of the coating material is sized such that adjacent magnetic nanoparticles are exchange coupled.

8. The soft magnetic material of claim 1, wherein the soft magnetic material is formed by compacting the magnetic nanoparticles.

9. A soft magnetic material comprising:
a plurality of magnetic nanoparticles, wherein the magnetic nanoparticles are comprised of:
a first soft magnetic material forming a core;
a second soft magnetic material forming a shell around the core; and
a third material forming a coating around the shell.

10. The soft magnetic material of claim 9, wherein the first and second soft magnetic materials each have an exchange length, and wherein the exchange length of the second soft magnetic material is longer than the exchange length of the first soft magnetic material.

11. The soft magnetic material of claim 9, wherein each magnetic nanoparticle is configured such that the first and second soft magnetic materials of each magnetic nanoparticle are exchange coupled.

12. The soft magnetic material of claim 9, wherein the thickness of the coating is sized such that the second soft magnetic material of adjacent magnetic nanoparticles are exchange coupled.

13. The soft magnetic material of claim 9, wherein the core and the shell of each magnetic nanoparticle are sized such that they are each single domain.

14. The soft magnetic material of claim 9, wherein the first soft magnetic material comprises the elements Fe and Co and the second soft magnetic material comprises the elements Fe and Ni.

15. The soft magnetic material of claim 14, wherein the first soft magnetic material comprises FeCo and the second soft magnetic material comprises Ni₃Fe.

16-17. (canceled)

18. A soft magnetic material comprising magnetic nanoparticles, wherein the magnetic nanoparticles are comprised of a mixture of two different types of magnetic nanoparticles, wherein each type of magnetic nanoparticles has characteristics that contribute to desired magnetic properties.

19. The soft magnetic material of claim 18, wherein a first type of magnetic nanoparticle contains a material that has a high magnetization property.

20. The soft magnetic material of claim 19, wherein a second type of magnetic nanoparticle contains a material that has a relatively high exchange length to provide desired exchange coupling characteristics.

21. The soft magnetic material of claim 18, wherein a first type of magnetic nanoparticles comprise the elements Fe and Co.

22. The soft magnetic material of claim 21, wherein a second type of magnetic nanoparticles comprise the elements Fe and Ni.

23. The soft magnetic material of claim 21, wherein the first type of magnetic nanoparticles comprises FeCo and the second type of magnetic nanoparticles comprises Ni₃Fe.

24. The soft magnetic material of claim 18, wherein the magnetic nanoparticles are single domain particles.

25. The soft magnetic material of claim 18, wherein at least some of the magnetic nanoparticles include a magnetic coating material.

26-28. (canceled)

29. The soft magnetic material of claim 18, wherein the magnetic nanoparticles further comprise a third type of magnetic nanoparticles.

30. A method of making soft magnetic material using magnetic nanoparticles comprising:
forming a plurality of magnetic nanoparticles using two or more different compounds that provide different desired magnetic properties;
configuring the magnetic nanoparticles to be single domain particles;
configuring the magnetic nanoparticles to enhance exchange coupling;
coating the magnetic nanoparticles using a magnetic material, wherein the coating of magnetic material is configured to have a thickness that allows exchange coupling of adjacent magnetic nanoparticles; and
compacting the magnetic nanoparticles.

31. The soft magnetic material of claim 9, wherein the third material is a magnetic material.

32. The soft magnetic material of claim 9, wherein the soft magnetic material is formed by compacting the magnetic nanoparticles.

33. The soft magnetic material of claim 18, wherein the two types of magnetic nanoparticles are distributed substantially evenly.

34. The soft magnetic material of claim 18, wherein the two types of magnetic nanoparticles are distributed unevenly.

35. The soft magnetic material of claim 18, wherein the soft magnetic material is formed by compacting the magnetic nanoparticles.
